(19) United States
(12) Patent Application Publication
(10) Pub. No.: US 2008/0150754 A1
(43) Pub. Date: Jun. 26, 2008

(54) REMOTE CONTROL SYSTEM FOR MEDICAL APPARATUS

(75) Inventor: Dieter Quendt, Esslingen (DE)

Correspondence Address: CASELLA & HESPOS, 274 MADISON AVENUE, NEW YORK, NY, 10016, US

(73) Assignee: CARL ZEISS SURGICAL GMBH, Oberkochen (DE)

(21) Appl. No.: 11/950,696

(22) Filed: Dec. 5, 2007

(30) Foreign Application Priority Data
May 12, 2006 (DE) 10 2006 058 359.0

(51) Int. Cl. H04Q 9/00

(52) U.S. Cl. 340/870.07

(57) ABSTRACT

A cableless remote control system (2) for a medical device is provided. The remote control system (2) comprises a first battery (16), a second battery (18), a control module (10) for attaching or for installing in the medical device (8), at least one remote control operating unit (6) and a charging station (4). The first battery (16) is arranged in the remote control unit (6), the second battery is allocated to the charging unit (4).

### BACKGROUND OF THE INVENTION

1. Field of the Invention

The invention relates to a cableless remote control system for medical devices and a method for charging a battery of a remote control.

2. Description of the Related Art

In cableless remote controls for surgical devices or optical observation devices, particularly surgery microscopes, the necessary control signals are transmitted wirelessly instead of via a cable. For this purpose, a network link, for example Bluetooth, is used. For a medical remote control, Bluetooth is a suitable transmission technology because the frequency used is permitted throughout the world and the transmission technology is relatively secure against interference. To build up the voltage necessary for the network link, an internal power supply, i.e. a power source in the form of a battery is used.

DE 102 35 956 A1 discloses an arrangement for the wireless transmission of actuating signals to a number of medical devices. In the medical devices, receivers are provided which receive actuating signals of the transmitter wirelessly transmitted by servo units. These servo units are provided with interchangeable energy stores which can be exchanged or charged at a central charging station.

To avoid that, in the case of a number of servo units of the same type, a wrong servo unit is registered at the medical device, the individual servo units have identifications. These identifications can be transmitted contactlessly by means of optical or inductive transmission as part of a registration process.

WO2006/050410 discloses a device and a method for controlling medical devices by means of a cableless remote control. The wireless connection between the remote control and the device to be controlled can be made, for example, by means of Bluetooth. The battery in the remote control is charged by electromagnetic induction. It is also possible to use a number of wireless remote controls in the near vicinity. To prevent signals generated by different remote controls from driving the wrong devices, each device is equipped with an ID code which is recognized by the remote control.

It is disadvantageous that, for example, Bluetooth is a network transmission and the network of remote control and device to be controlled must be continuously maintained even if no control commands are being exchanged at the time. This results in relatively high power consumption of the remote control. For this reason, the remote control is supplied by a battery which must be charged after (almost every) use in order to ensure its operability.

In many operating theatres, however, the power supply is centrally switched off if it is not used or the device to be controlled, for example a surgery microscope, is stored after its use in a storage room without power connection so that charging in the vicinity of the device is not possible. It is thus not ensured in every case that the remote control is adequately charged over the entire storage period if the remote control is to remain in the vicinity of the device.

After the remote control and the device to be controlled are switched on, the network link must first be built up. However, this can only take place if the battery of the remote control has an adequate charge. In addition, it could happen that a remote control of identical construction from a neighboring room builds up an unwanted connection to the device to be controlled if no precautionary measures are taken. The risk is particularly great if the actual remote control of the device is not adequately charged.

The invention is based on the first objective of providing a cableless remote control system for a medical device and such a device with a remote control in which an adequate state of charge of the battery of a remote control can be maintained even without permanent connection to the mains power supply.

A second objective consists in providing a method for charging a battery of a remote control.

### SUMMARY OF THE INVENTION

According to the invention, the solution of the objective consists in a cableless remote control system for a medical device. The remote control system comprises at least one first battery, at least one second battery, a control module for attaching or for installing in the medical device, at least one remote control operating unit and a charging station. The first battery is arranged in the remote control operating unit and the second battery is allocated to the charging station to supply it with electrical energy. In particular, the second battery can be integrated into the charging station. The control module is arranged for outputting control signals for the medical device. The cableless remote control operating unit can be arranged, for example, as manual remote control, as foot pedal console, as mouth-operated switch, etc.

Due to the fact that the remote control system is cableless, a tripping hazard due to cables lying on the floor inside the operating theatre is avoided. In addition, the cableless construction allows a simpler installation and handling of the devices. The charging station which, in particular, can be integrated into the device to be controlled or can be attached to it is associated with a battery so that it can continue to supply a remote control operating unit located in the charging station with energy if it is disconnected from the power system. This makes it possible to reliably ensure an adequate charge in the remote control operating unit even if the device should remain disconnected from the power system supply over a relatively long period of time.

In an advantageous development, the cableless remote control system uses a transmission technology which is based on radio signals between the remote control operating unit and the control module at or in the device to be controlled and, in particular, can be arranged as a Bluetooth network link. The Bluetooth link provides for a wireless radio networking in the so-called 2.4 GHz ISM band which allows unlicensed transmission for industrial, scientific and medical purposes.

The battery which is allocated to the charging station can have a capacity which is at least as great as the capacity of the battery in the remote control operating unit, preferably even greater. This makes it possible to prevent a complete discharge of the second battery due to the charging of the first battery over a long period of time.

In addition, the charging station and the remote control operating unit of the cableless remote control system can in each case comprise an induction coil. The coils are then matched to one another in such a manner that the first battery can be charged via an inductive magnetic field. Since the inductive charge does not require any plug-in contacts, the surfaces of the charging station and of the remote control operating unit can be kept smooth which simplifies sterilization.

In the cableless remote control system, a modulator/demodulator for modulating the inductive magnetic field can be allocated in each case to the coils of the charging station and of the remote control operating unit. In addition to the inductive charging, a signal transmission for the registration procedure between the remote control operating unit and the device to be controlled can then take place as part of inductive coupling by means of the modulation/demodulation of the inductive magnetic field. The short range of the inductive coupling prevents, during the registration, an unwanted connection between devices which are farther and which are not to be registered. A further advantage of the modulators/demodulators allocated to the two charging coils is that, in addition to the coils, no further inductive coupling is necessary for the inductive registration procedure.

According to the invention, a medical device, particularly a surgery microscope, comprising a cableless remote control system according to the invention is also provided. The medical device can also be another optical observation device, for example an endoscope. Surgical devices such as, for example, devices for intraoperative radiation therapy, which can be controlled by the remote control system according to the invention, can also be considered as devices. Another surgical device considered is a phaco device. Such a device comprises a so-called phaco tip, also called phaco end piece, and is used for removing the lens. Phaco devices have, for example, an ultrasonic generator which generates ultrasonic vibrations disintegrating the lens, which are conducted to the distal end of the phaco tip. The distal end is used for selectively introducing the ultrasonic vibration into the lens in order to disintegrate it. The disintegrated lens is then sucked off by a suction line. In addition, phaco tips can also have blades by means of which cuts can be made in the lens.

The control module and/or the charging station can be installed in the medical device. This avoids additional housing parts and achieves a simple and clear design of the medical device. In addition, the remote control operating unit is then always with the device when it is charged. It is thus always at hand when the device is to be taken into operation. In this case, the second battery, that is to say the battery allocated to the charging unit, is also installed in the medical device.

However, the control module and/or particularly the charging station can also be attached detachably at the medical device. The charging station is then mobile and can be used independently of the installation site of the medical device. The battery allocated to the charging station is integrated into the charging station in this case.

Furthermore, a method for charging a battery arranged in a remote control operating unit of a remote control system according to the invention is provided in which the energy needed for charging the first battery is provided by the second battery. This makes it possible to charge the first battery if the charging device does not have a connection to a power system.

The second battery is advantageously charged while the remote control system is in operation. As a rule, the second battery is then fully charged when the remote control system is taken out of operation and disconnected from the power system.

The signal can be transmitted from the remote control operating unit to the device to be controlled by means of a radio network link. As mentioned above, the advantage of a radio link is networking of devices without disturbing cables.

In an advantageous development of the invention, the remote control operating unit recognizes when it does not have a charging contact to the charging station and the radio network link to the device is interrupted over a particular period of time. It then generates a signal, for example a light signal or a signal tone. If the remote control operating unit finds that there is no network link to the device, this can mean that the device is switched off. If there is additionally no charging contact to the charging station, the risk is that the device is stored with the remote control system without power supply and it has been forgotten to establish the charging contact of the remote control operating unit to the charging station. The operating personnel can be alerted by the signal so that it can bring the remote control operating unit into charging contact in order to ensure a charging of its battery.

The remote control operating unit can also generate a warning signal if the state of charge of its battery is too low. The warning signal can be acoustic or optical. In this manner, the operating personnel can be alerted if recharging has to be carried out.

In addition, the remote control operating unit can visually indicate the state of charge of its battery. This provides automatic information to the operating personnel about the state of charge of the battery in the remote control operating unit so that charging of the remote control operating unit can be initiated before a minimum charge of its battery is exceeded.

According to the invention, the first battery can be charged contactlessly, for example inductively, by the second battery. This avoids charging cables. Smooth and sterilizable surfaces of remote control operating unit and charging station are possible. In principle, however, charging via charging contacts, for example in the form of plug-in contacts, is also possible.

The remote control operating unit can be advantageously registered at the control module at or in the device to be controlled also by the inductive coupling of the charging station. No further additional components are then needed.

### BRIEF DESCRIPTION OF THE DRAWINGS

Further features, characteristics and advantages of the invention are found in the subsequent description of exemplary embodiments, referring to the attached figures, in which:

FIG. 1 shows a surgery microscope with a moving stand,

FIG. 2 shows the degrees of freedom of the stand from FIG. 1,

FIG. 3 shows a diagrammatic representation of a remote control system in the charging phase of the battery in the device to be controlled,

FIG. 4 shows a greatly simplified block diagram of the charging station and of the remote control operating unit,

FIG. 5 shows the remote control system from FIG. 3 during the charging of the battery in the remote control operating unit, and

FIG. 6 shows an alternative arrangement of the elements of a remote control system during the charging of the battery in the remote control operating unit.

### DETAILED DESCRIPTION OF THE PREFERRED EMBODIMENT

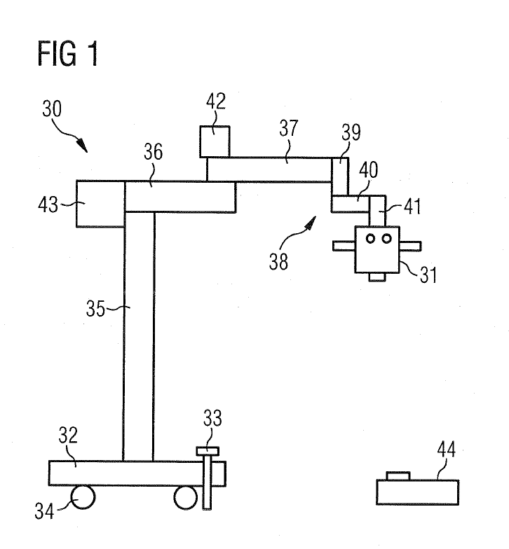

FIG. 1 diagrammatically shows a surgery microscope 31 with a stand 30 as an example of a medical device in which a remote control system according to the invention can be used. The stand 30 rests on a foot 32 at the underside of which rollers 34 are present which enable the stand 30 to be moved. To prevent an unwanted movement of the stand 30, the foot 32 also has a foot brake 33.

To remotely control the stand and/or the surgery microscope 31, there is a foot pedal console 44 as remote control operating unit which is connected to a control module (not shown) in the surgery microscope 31 via a radio network link.

The stand 30 comprises a height-adjustable stand column 35, a support arm 36, a spring arm 37 and a microscope suspension 38 which, in turn, comprises a connecting element 39, a swiveling arm 40 and a holding arm 41.

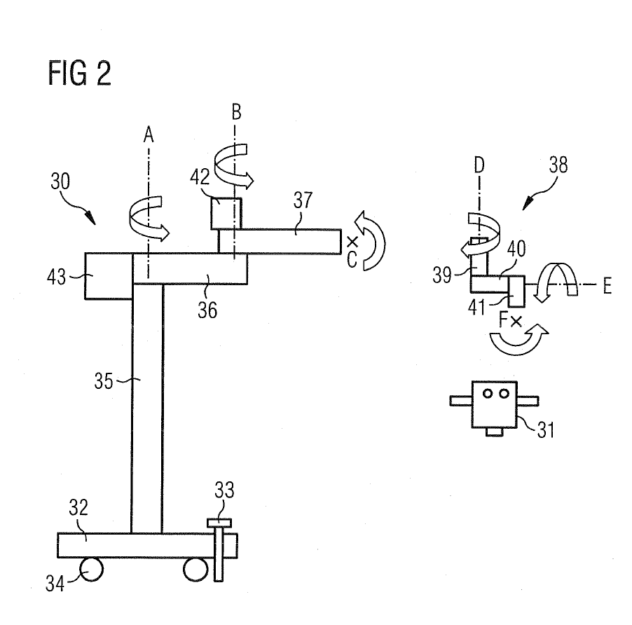

The degrees of freedom provided by the stand elements for positioning the surgery microscope 31 are shown in FIG. 2. The support arm 36 is connected at its one end rotatably about an axis A to the stand column 35. At the other end of the support arm 36, one end of the spring arm 37 is attached rotatably about an axis B parallel to the axis A so that the support arm 36 and the spring arm 37 form one hinged arm. The other end of the spring arm 37 is formed by a tilting mechanism (not shown) at which the microscope suspension 38 is attached and which enables the microscope suspension 38 to be tilted about the axis C.

The microscope suspension 38 has an axis of rotation D, a swiveling axis E and a tilting axis F around which the microscope 31 can be rotated, swiveled and tilted. The microscope suspension 38 is attached rotatably about the axis of rotation D at the outer end of the spring arm 37 by means of a connecting element 39. The axis of rotation D extends along the connecting element 39. The connecting element 39 is adjoined by a swiveling arm 40 with the aid of which the microscope 31, more precisely a holding arm 41 attached to the swiveling arm 40, at which the microscope 31 is attached by means of a microscope holder (not shown), can be swiveled about the swiveling axis E. The swiveling axis E extends through the swiveling arm 40. The angle between swiveling arm 40 and connecting element 39, i.e., the angle between the swiveling axis E and the axis of rotation D can be varied by means of an adjusting mechanism arranged between the connecting element 39 and the swiveling arm 40.

The tilting axis F which enables tilting of the surgery microscope 31 extends perpendicularly to the plane of representation through the holding arm 41. The surgery microscope 31 is attached to the holding arm 41 by means of a microscope holder, not shown.

To prevent an unwanted adjustment of the microscope 31 from a selected position, the stand elements or hinges between the stand elements are provided with brakes (not shown) which are fixed after the microscope 31 has been positioned. Both manual brakes and electrically operated brakes can be considered as brakes.

In addition, a light source 42 for object illumination and a mains connection device and an operating element 43 for electrical components of the microscope 31 and possibly of the stand 30 are arranged at the stand 30.

The foot pedal console 44 is used for carrying out the optical adjustments and fine positioning of the microscope. The remaining possible adjustments, particularly the adjustment and fixing possibilities described above can be operated via a remote control operating unit.

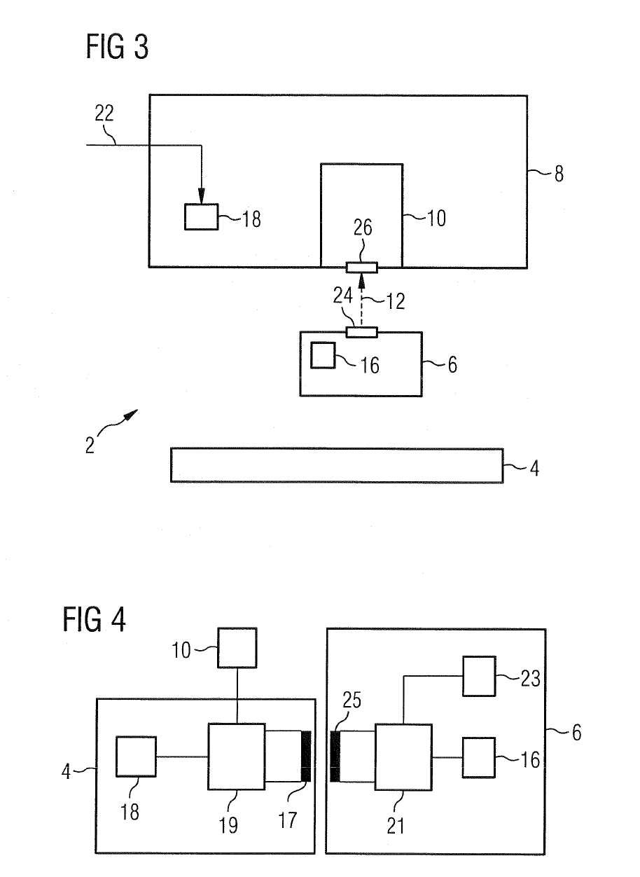

FIGS. 3 and 5 show a first exemplary embodiment of a remote control system 2 according to the invention. This comprises a charging station 4, a remote control operating unit 6 which will be briefly called remote control in the text which follows, and a control device 10 which is integrated into a surgery microscope 31 as the device 8 to be controlled. The remote control 6 has a first battery 16, also called remote control battery 16 in the text which follows, and a transmitter 24. The device 8 to be controlled is equipped with a second battery 18, also called device battery 18 in the text which follows, which is allocated to the charging station 4, and with a receiver 26 connected to the control device 10. The device battery 18 is used as a power source for the charging station 4 if it is not connected to a power system. Since, in the present exemplary embodiment, the charging station 4 is not integrated into the device 8 to be controlled but is constructed as an individual unit, it can be connected to the device battery 18 via a conductive connection which can be constructed, for example, as a cable. However, the conductive connection can also be constructed as a plug-in connection between the charging station 4 and the outside of the device 8 to be controlled. The remote control battery 16 is arranged in the remote control 6 (FIGS. 3 and 5).

The transmitter 24 of the cableless network link is a radio transmitter or, respectively, a Bluetooth transmitter, the receiver 26 is a radio receiver, for example a Bluetooth receiver.

In an alternative arrangement of the remote control system according to the invention, the charging unit 4 can also be integrated into the medical device 8. Similarly, the second battery 18 can also be installed in the medical device 8.

FIG. 3 represents the remote control system 2 during the charging phase of the battery 18 which, in the present exemplary embodiment, is integrated into the device 8 to be controlled. The device battery 18 is charged by a mains connection 22 while the device 8 to be controlled is in operation. During the operation, the previously charged remote control battery 16 supplies the remote control 6 with energy.

When the remote control system 2 is in operation, the transmitter 24 of the remote control 6 sends control signals 12 to the receiver 26 of the control unit 10 via a wireless network link, for example Bluetooth or W-LAN. The signals are processed in the control unit 10 and converted into electrical signals for acting on the actuators of the device 8 to be controlled, in this case the surgery microscope 31 or also the stand 30.

The remote control battery 16 is charged by the device battery 18 by means of inductive coupling when the remote control 6 is in the charging station 4. FIG. 4 shows the inductive coupling between the remote control 6 and the charging station 4 in the form of a greatly simplified block diagram.

The remote control 6 comprises a processor 23, a modulator 21 which can also operate as demodulator, and a coil 25. A second coil 17 and a second modulator 19 which can also operate as demodulator are arranged in the charging station 4.

In the remote control 6, the processor 23 is connected to the first modulator/demodulator 21 which, in turn, is connected to the first coil 25. The modulator/demodulator 19 in the charging station 4 is connected both to the coil 17 and to the control unit 10 installed in the device 8 to be controlled, for example via a further cable or, if there is a plug-in connection between charging station and device 8, via the plug-in connection.

Apart from the charging of the remote control battery 16, the registration of the remote control 6 with the control unit 10 also takes place via the inductive coupling.

When the remote control 6 is registered at the device 8, the processor 23 outputs the digital signals of the registration procedure to the first modulator 21. On the basis of the digital signals, the latter modulates the inductive magnetic field generated by the first coil 25. This modulated magnetic field then induces in the second coil 17 a modulated voltage which is demodulated by the demodulator 19 and converted into digital signals. The digital signals are supplied to a processor (not shown) of the control device 10. The sequence described can also take place in the reverse direction as part of the registration procedure.

There can be a number of remote controls 6 of the same type. So that the various remote controls drive the correct devices, each remote control must be registered at the corresponding device. The respective remote control 6 is registered at the respective device 8 via the inductive coupling which is described above. Due to the short range of the inductive coupling, the registration occurs at the nearest device, as a rule. Since the remote control is usually located in the same room as the device and the inductive coupling can normally be carried out only within the room, a registration at a “wrong” device in the neighboring room which could be achieved without problems via the wireless network link, can be reliably prevented.

FIG. 5 shows the remote control system 2 from FIG. 3 during the charging phase of the battery 16 in the remote control 6. The charged device battery 18 in the device 8 to be controlled is connected to the charging station 4, and supplies it with energy, via the conductive connection 14. The remote control 6 with the remote control battery 16 is located at the charging station 4 which contactlessly charges the remote control battery 16 by inductive coupling (see FIG. 4). During the charging, the current from the coil 25 is guided around the demodulator 21 (not shown in the block diagram) and conducted directly into the battery 16. Since the inductive charging operates contactlessly, the remote control 6 only needs to be located in the vicinity of the charging station during the charging. To guarantee optimum induction in the coil 25 of the remote control 6, however, it may be advantageous to construct the charging station 4 in such a manner that it enables the remote control 6 to be fixed in a particular position relative to the charging station.

If the device battery 18 has a larger capacity than the remote control battery 16, it can provide charging energy for the remote control battery 16 over a relatively long period of time. The same can be achieved if, instead of one device battery having a greater capacity than that of the remote control battery, two or more device batteries 18 having the same capacity as that of the remote control battery 16 are present.

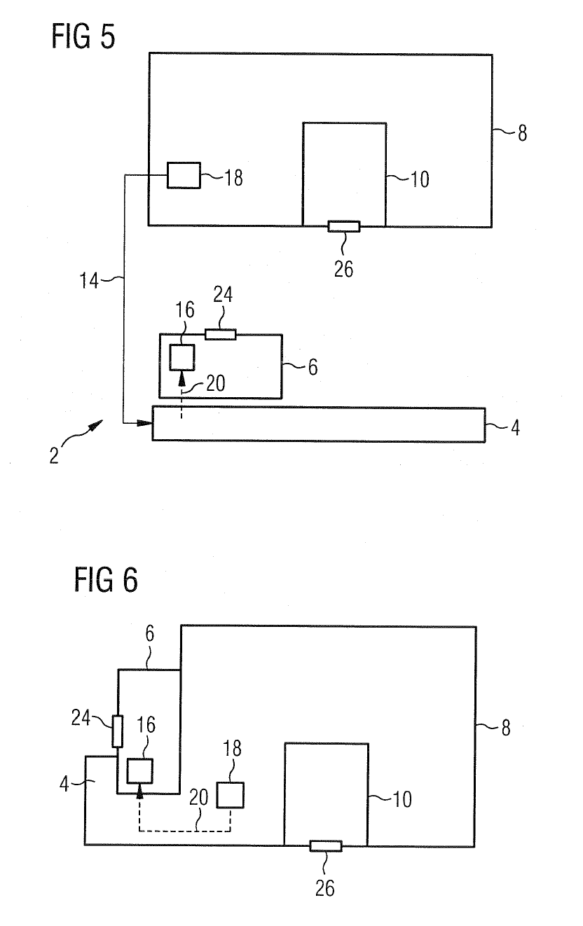

FIG. 6 shows a second exemplary embodiment of the remote control system according to the invention. In this exemplary embodiment, the charging station 4 is integrated into the device 8 to be controlled and is used, at the same time, as holder for the remote control 6. The device battery 18 can be integrated into the control device 10 or in the charging station 4. For the rest, the second exemplary embodiment does not differ from the first exemplary embodiment. In both exemplary embodiments, identical elements are therefore provided with the same reference symbols.

All adjustable elements of the stand 30 and the optical adjustments of the microscope can be adjusted by electrical servo units with the aid of the remote control system according to the invention. Instead of the foot pedal console 44 shown in the drawings, a manually operated or mouth-operated remote control is also possible as remote control.

Although in each case only one battery has been described in the remote control 6 in the exemplary embodiments, the remote control 6 can also comprise two or more batteries 16.

What is claimed is:

1. A cableless remote control system (2) for a medical device (8) comprising:
a control module (10) for attaching or for installing in the medical device (8), the control module configured for receiving at least one control signal for controlling an operation of the medical device (8),
at least one remote control operating unit (6) configured for generating the at least one control signal,
at least one first battery (16) arranged in the remote control operating unit (6);
a charging station (4), and
at least one second battery (18) allocated to the charging station (4), wherein the at least one second battery (18) charges the at least one first battery (16).

2. The cableless remote control system (2) of claim 1, further comprising a radio network link connection between the remote control operating unit (6) and the medical device (8) to be controlled, the radio network link accommodating the at least one control signal.

3. The cableless remote control system (2) of claim 1, wherein the second battery (18) has a capacity that is greater than a capacity of the first battery (16).

4. The cableless remote control system (2) of claim 1, wherein the charging station (4) comprises a first coil (17) and the remote control operating unit (6) comprises a second coil (25), the first and second coils (17, 25) being matched to one another so that the first battery (16) can be charged via an inductive magnetic field.

5. The cableless remote control system (2) of claim 4, further comprising a first modulator/demodulator allocated to the first coil (17) for modulating and demodulating the inductive magnetic field of the first coil (17) and a second modulator/demodulator allocated to the second coil (25) for modulating and demodulating the inductive magnetic field of the second coil (25).

6. The cableless remote control system (2) of claim 1, wherein the second battery (18) is integrated into the charging station (4).

7. A medical device (8) comprising:
a remote control system (2) having a control module (10) for attaching or for installing in the medical device (8), the control module (10) configured for receiving at least one control signal for controlling an operation of the medical device (8),
at least one remote control operating unit (6) configured for generating the at least one control signal,
at least one first battery (16) arranged in the remote control operating unit (6);
a charging station (4), and
at least one second battery (18) allocated to the charging station (4), wherein the at least one second battery (18) charges the at least one first battery (16).

8. The medical device (8) of claim 7, wherein the control module (10) is installed in the medical device (8).

9. The medical device (8) of claim 7, wherein the charging station (4) is installed in the medical device (8).

10. The medical device (8) of claim 9, wherein the second battery (18) is installed in the medical device (8).

11. The medical device (8) of claim 7, wherein the charging unit (4) is attached detachably at the medical device (8).

12. A method for charging a battery (16) arranged in a remote control operating unit (6) of a remote control system for a medical device (8), the remote control system comprising at least one first battery (16), at least one second battery (18), a control module (10) for attaching or for installing in the medical device (8), and a charging station (4), the first battery (16) being arranged in the remote control operating unit (6) and the second battery (18) being allocated to the charging station (4), the method comprising charging the first battery (16) with energy provided by the second battery (18).

13. The method of claim 12, further comprising charging the second battery (18) while the remote control system is in operation.

14. The method of claim 12, further comprising transmitting a control signal via a radio network link from the remote control to the device to be controlled.

15. The method of claim 14, in which the remote control operating unit (6) outputs a signal if it has no charging contact to the charging station (4) and the radio network link is interrupted over a particular period of time.

16. The method of claim 12, wherein the step of charging the first battery (16) comprises charging the first battery (16) contactlessly by the second battery (18).

17. The method of claim 16, wherein the step of charging the first battery (16) comprises charging the first battery (16) inductively by the second battery (18).

18. The method of claim 17, further comprising registering the remote control operating unit (6) at the control module (10) by an inductive coupling of the charging station (4).

19. The method of claim 12, further comprising generating a signal at the remote control operating unit (6) for indicating a state of charge of the first battery (16).

20. The method of claim 12, further comprising generating a warning signal at the remote control operating unit (6) when the state of charge of the first battery (16) is too low.
